(19) United States
(12) Patent Application Publication
(10) Pub. No.: US 2014/0317443 A1
(43) Pub. Date: Oct. 23, 2014

(54) METHOD AND APPARATUS FOR TESTING A STORAGE SYSTEM

(71) Applicant: International Business Machines Corporation, Armonk, NY (US)

(72) Inventors: Eric J. Bartlett, Salisbury (GB); Alastair Cooper, Winchester (GB); Nicholas M. O'Rourke, Southampton (GB)

(73) Assignee: International Business Machines Corporation, Armonk, NY (US)

(21) Appl. No.: 14/225,758

(22) Filed: Mar. 26, 2014

(30) Foreign Application Priority Data
Apr. 23, 2013 (GB) 1307301.0

(51) Int. Cl. G06F 3/06

(52) U.S. Cl. CPC G06F 3/0659; G06F 3/0619; G06F 3/0683
USPC 714/6.11; 711/154

(57) ABSTRACT

A method and a system for testing a storage system to which is applied a command or a sequence of commands. The storage system has a storage medium and a controller, and each command results in an outcome, and the method comprises: storing in a dataset; information related to the command and/or the sequence of commands including for each command: an address of the storage system the command is applied to, and an outcome of the command. When a sequence of commands is applied, the information stored in the dataset includes an outcome of the sequence of commands. This method further comprises selecting one or more commands from the dataset to be subsequently replayed when the outcome of the at least one command indicates an error.

### CROSS-REFERENCE TO RELATED APPLICATIONS

This application claims the benefit of priority from United Kingdom patent application number GB 1307301.0, filed Apr. 23, 2013, which is hereby incorporated by reference in its entirety.

### FIELD OF THE INVENTION

The present invention relates in general to testing of storage systems, and particularly to a method for testing a storage system, and an apparatus for testing a storage system.

### BACKGROUND

Modern storage systems involve a controller and one or more storage mediums for storing data which is accessed by the controller by means of commands. A storage medium is typically a physical device or a drive such as a Hard Disk Drive (HDD) or a Solid State Drive (SSD) or a non-volatile memory such as a Flash or the like. In general, the storage medium is used entirely by a single Logical Unit (LUN) or is part of a LUN as a LUN may span several storage mediums. However, this case, which is historically the norm, is changing and modern systems can configure several LUNs on a single storage medium.

FIG. 1 illustrates such a storage system 1 comprising at least one storage medium 2 configured in a number of Logical Units including LUN1 4, LUN2 7 and LUN3 6. Note that FIG. 1 does not show the underlying physical drive upon which are partitioned the Logical Units. Each Logical Unit is further subdivided in several logical blocks. A logical block is a portion of the Logical Unit which can store useful data for a user. Data is stored on logical blocks (on the storage medium) along with information that a controller or an application would use to manage the data and its retrieval. In FIG. 1 for example, the logical unit LUN1 4 contains a number “n” of logical blocks indicated by the notations LB1 12 to LBn 13. Each logical block within a Logical Unit of a storage system is uniquely referenced by an address noted a Logical Block Address or LBA. Therefore, a LBA identifies the location of a logical block where data may be stored on a drive. The LBAs referencing logical blocks are generally incrementing linearly from the first one to the last logical block of the Logical Unit. The LBAs are also contiguous such as for example when the first LBA of a Logical Unit is one, the second LBA of the same Logical Unit is two. Finally the last Logical Block Address is “n” which represents the number of logical blocks on the logical unit of the storage system.

FIG. 1 shows, in reference to the LUN1 4, the first LBA1 10 pointing to the logical block LB1 12 and the last LBA of LUN1 denoted LBAn 11 pointing to the logical block LBn 13. Each further logical unit LUN2 7, LUN3 6 in FIG. 1 has a similar structure as that of LUN1 4. Typically, a LBA is no longer than 8 bytes, and a short LBA is typically only four bytes. It will be apparent to one skilled in the art that a LBA may be any address arbitrarily configured to reference any portion of a storage medium. In a storage system, a command is typically issued by an application or by a controller 3 to access an address of the storage system such as a LBA. A command accessing a logical block typically uses the LBA of the block in an input field. Examples of such commands include the “Read” and the “Write” commands which serve to read a portion of the storage medium and to write to a portion of the storage medium. FIG. 1 graphically illustrates such a command, denoted by R/W REQ 8, in the form of an arrow originating from the controller CTRL 3 and terminating on the storage medium 2. FIG. 1 shows only one storage medium 2, but there could be several storage mediums in the storage system. A Read command 8 executed by the controller CTRL 3 to read a portion of the storage medium 2 will typically include a LUN identifier (e.g an identifier for each of the Logical Units LUN1 4, LUN2 7, LUN3 6 . . . ) and an address or a LBA indicating the first address of the storage medium the command should be reading from.

A Write command 8 to write on the storage medium would also include the LUN identifier and the starting address or the LBA from which the command should be writing to. Each such command 8 will trigger a response 9 which will return an outcome of the requesting command 8. For example, a response to a read command ordering to read from an address will indicate to the controller CTRL 3 whether the read was actually successful or failed. The same applies for a response to a Write request or to any other type of request applied to a storage system/medium. It is assumed throughout this application that if a request fails, a response to the requesting command indicates the type of error and if appropriate the logical address or LBA referencing the logical block where the error occurred. Transport mechanisms may use Serial Advanced Technology Attachment (SATA) or Small Computer System Interface (SCSI) of Fibre technology. Examples of commands include the “Read (10)”, the “Write (10)” and the “Test Unit Ready”, which are defined by the SCSI standard. A typical “Read” command (e.g SCSI Read (10)) contains a LBA field and a “Length” specifying the number of contiguous blocks that shall be read (i.e transferred from the storage medium to a cache memory) starting with the logical block specified in the LBA field. A “Write” command (e.g SCSI write (10)) typically requests a transfer (from the controller or an application) of data from a data buffer to be written on a LUN at a location starting at a logical block specified by a LBA. If a Read request or a Write request to a logical unit fails, an error is reported in the response 9 to that request 8. A Test Unit Ready command (SCSI test Unit ready) is a command that an application may issue to check whether a removable medium is mounted or whether the storage medium is ready to transfer data. It is noted that the Test Unit Ready does not contain information about any LBA. When a Test Unit Ready command is applied to a storage medium, a status indicative of the readiness of the storage medium or of a failure will be returned. A failure can be caused by one or multiple errors.

Many error types exist including a “medium error”, a “transport error”, a “drive internal error”, a “command taking longer than expected”, a “command timeout with successful retry”. The ‘command taking longer than expected’ and the ‘command timeout with successful retry’ type errors are not necessarily represented by the command response. Instead these conditions are detected by the controller that records how long commands take and defines what are the acceptable command durations (which can be medium type or product specific). Errors may be due to software problems such as a software crash for example, and/or hardware problems such as a failure of a hard disk to spin properly. The aforementioned list is of course not exhaustive and other errors or outcomes indicative of an abnormal behaviour may be monitored. Typically a “medium error” on a drive of the storage system can be reported in a response to a request sent to a drive. For example, when a storage medium 2 receives a data Read request, a “medium error” occurs if an error detection code generated from the read data does not match the error detection code stored in a storage area of the system. A SCSI Key Code Qualifier or SKCQ returned by a SCSI device can be used for reporting an error including an internal error. The request to a drive can be sent as part of a routine check executed by one or more test commands such as the “Test Unit Ready” or as part of a normal Read/Write operation request.

In today's storage systems, in the face of a failure, certain recovery solutions exist including Error Recovery Process or ERP. When a medium error is detected during the course of a check, the ERP attempts to restore the data where the medium error had occurred onto a recovery area. Examples of ERPs include Logical Unit Reset or drive reboot. It is reminded that the determination of the position of the logical block where the medium error is detected is given by the value of the LBA returned in the response 9 to the requesting command 8. After an ERP (e.g drive ERP, or a drive reboot) has been completed, it is important to verify that the ERP has worked and the drive is restored to a usable working state. Today's controller products use preset sequences of commands to verify that the behaviour of the drive has been restored after a failure. These commands include the Test Unit Ready and the “Read predefined LBA”. However these solutions do not take into account any details of the type of failure, the association between a failure and a LBA. This set of information could provide a more thorough means of testing whether a storage medium (e.g a drive) has been restored into a healthy working condition after a failure or is still suffering some impairment.

### SUMMARY OF THE INVENTION

The inventors of the present invention have determined that it is desirable to provide a method for testing accurately a storage system. The method may comprise building a dataset (e.g., a database) of information in which is recorded primarily the commands that generated errors and the LBAs of blocks where these errors occurred for later replaying these commands. The commands may be replayed in a selected sequence.

Accordingly, a first aspect of the invention provides a method for testing a storage system to which is applied a command, the storage system having a storage medium and a controller, the command resulting in an outcome, the method comprising: storing in a dataset; information related to the command including: an address of the storage system the command is applied to, an outcome of the command.

In one embodiment, when a sequence of commands is applied to the storage system, information related to the at least one command of the sequence is stored in the dataset including an outcome of the sequence of commands.

In one particular method according to this first aspect of the invention, the information related to the at least one command is stored in the dataset when the outcome of the at least one command is indicative of a fault. It advantageously provides recording an error and replaying the command or the sequence of commands that caused the fault at a later time to ascertain whether the fault remains.

In one embodiment, the outcome of a sequence of commands is indicative of a fault when the outcome of the at least one command of the sequence is indicative of a fault. In one embodiment, the fault is an error on the storage medium at the address or an error internal to the storage medium or a faulty behaviour on the storage system. In one embodiment, the fault is an error that occurred during transportation of data between the controller and the storage medium. In one embodiment, the information related to the command further comprises an identifier of the storage medium and/or an identifier of a storage unit (i.e logical unit) which forms part of the storage medium. In one embodiment, the fault is indicated by a delay between the command and a response thereof when said delay is longer than a predetermined delay. One embodiment further comprises: selecting one or more commands from the dataset each according to its respective outcome for re-applying said selected the at least one command.

In one embodiment, a plurality of commands is selected from the dataset for re-applying each of the selected commands in the sequence the commands were applied. In one embodiment, a plurality of commands is selected from the dataset for re-applying each of the selected commands in a sequence different from the sequence in which the commands were applied. In one embodiment, the selection of the at least one command is based on a time of applying the at least one command or a time of storing the information related to the at least one command. That is, the time can be representative of the time when the at least one command occurred or the time when the information related to the at least one command was stored.

In one embodiment, each of the at least one selected command is re-applied and the outcome of each re-applied command is compared to the stored outcome of the respective command. In one embodiment, the outcome of the at least one command or sequence of commands re-applied is appended to the dataset. In one embodiment of the method, the storage system comprises a plurality of storage mediums, each storage medium having a respective identifier, and when a command or a sequence of commands is applied to one of the plurality of storage mediums, the information related to the command or the sequence of commands is stored in the dataset with the identifier of said storage medium. In one embodiment of the method the command is a request issued to the storage medium and the outcome of the command is in the response to the command. In one embodiment of the method the command is a read command, or a write command, or a command for probing the storage medium. In one embodiment, the storage medium is a Solid State Disk.

A second aspect of the invention provides a system comprising: a storage medium for storing data, a controller for sending a command to the storage medium and of receiving and processing a response thereof, the controller being capable of interpreting an outcome of the command as a failure or a success; a memory for storing a dataset of information related to the command or a sequence of such commands including for each command, an address of the storage system the command is applied to, the outcome of the command or an outcome of the sequence of such commands.

According to the second aspect of the invention, there is provided a memory in the system capable of storing the dataset of information according to any one embodiment of the method, and wherein the controller is operable to execute any of the method embodiments.

A third aspect of the invention provides a computer program product for testing a storage system, the computer program product comprising a computer-readable storage medium having computer-readable program code embodied therewith, the computer readable program code configured to carry out the method of any one of the method embodiments.

A fourth aspect of the invention comprises computer-executable program code instructions for controlling data processing apparatus to perform the method of the invention.

According to an aspect of the invention, there is provided a method or system substantially as hereinbefore described with reference to the accompanying drawings.

### BRIEF DESCRIPTION OF THE DRAWINGS

Preferred embodiments of the present invention will now be described, by way of example only, with reference to the following drawings in which:

FIG. 1 schematically depicts a background architecture of a storage system;

FIG. 2 schematically depicts an architecture according to one embodiment including a dataset;

FIG. 3 illustrates a flow diagram according to embodiments of the invention;

FIG. 4 illustrates a flow diagram according to other embodiments of the invention;

FIG. 5 is a flow diagram illustrating one way of using the dataset according to embodiments of the invention;

FIG. 6 is a flow diagram illustrating another way of using the dataset according to embodiments of the invention;

FIG. 7 illustrates a table of commands applied to a storage system such as that of FIG. 2; and

FIG. 8 illustrates a table including sequences of a set of commands applied to a storage system such as that of FIG. 2.

### DETAILED DESCRIPTION OF THE EMBODIMENTS

As will be appreciated by one skilled in the art, aspects of the present invention may be embodied as a system, method, computer program product or computer program. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments of this invention disclose a new method, a new system and a computer program product for providing a thorough means of testing a storage system.

An object of the invention is to construct a dataset of information containing information on commands or a sequence of commands that have stimulated an error or an unusual behaviour on a storage medium (e.g a device such as a SSD). The dataset of recorded commands contains for each command executed, the respective outcome thereof which represents a status indicating whether the command had succeeded or failed and the elapsed time or duration it took for the command to be executed. Thereafter the recorded information enables a targeted testing of previous problematic areas (e.g logical blocks of a logical unit) of a storage medium by replaying or re-applying selectively the commands that had reported errors or taken too long. Selectively replaying offending commands executed in the past, advantageously enable assessing whether a particular problematic situation has improved or remains unchanged. The storage system (e.g a drive) previous behaviour is used as an input into future health verification. Thus the method and the system presented in this invention facilitate accurate diagnosis of vulnerabilities. Additionally the invention may be an input to other systems that facilitate prompt recovery. It therefore provides a more efficient way of probing the health of a drive by re-applying selectively the commands rather than issuing a predetermined set of standard commands. If a replayed command keeps failing after a number of attempts, a conclusion that a target storage medium is not working properly may be reached. The method according to the invention implies a “self-learning approach” whereby the controller does not need to know anything specific about the storage medium or its internal parts. It also provides a single abstract method for testing the health of a storage system, which method can be tailored according to arbitrary sets of policies or rules.

A region of vulnerability whose address is recorded may be an error occurring due for example to a faulty hardware portion or an abnormal behaviour. As mentioned above, errors include medium errors, transport errors and internal errors. Other events that could be flagged as deficiencies may include “commands taking longer than expected” to complete. When a timeout associated with a command expires before a response to the command is received, a retry of the command may eventually work. The retry may have worked because the drive may have taken internal steps to recover or to complete the command. This sequence characterised by a first failed command followed by a successful retry of the command at a given LBA would typically be recorded in the dataset so that the region affected would be considered suspect or prone to failure.

Embodiments of the invention advantageously allow using test commands that the storage medium would be issued in normal processing.

For the purpose of this invention, it is assumed that, when there is a plurality of storage mediums in a storage system, each storage medium has a unique identifier within the storage system.

We now describe embodiments of the method with reference to the figures.

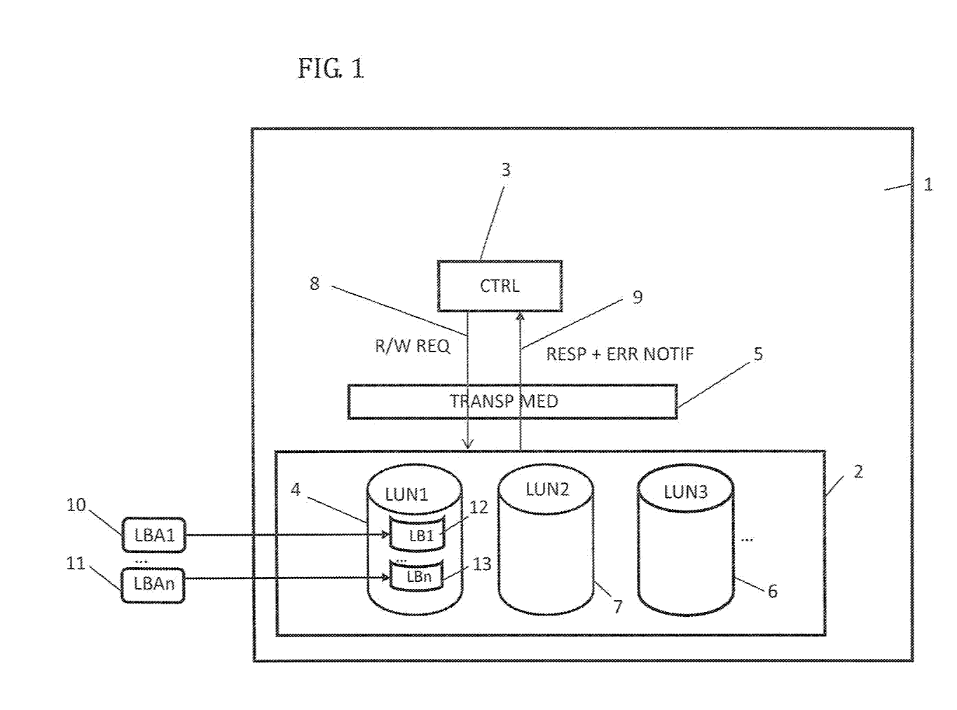

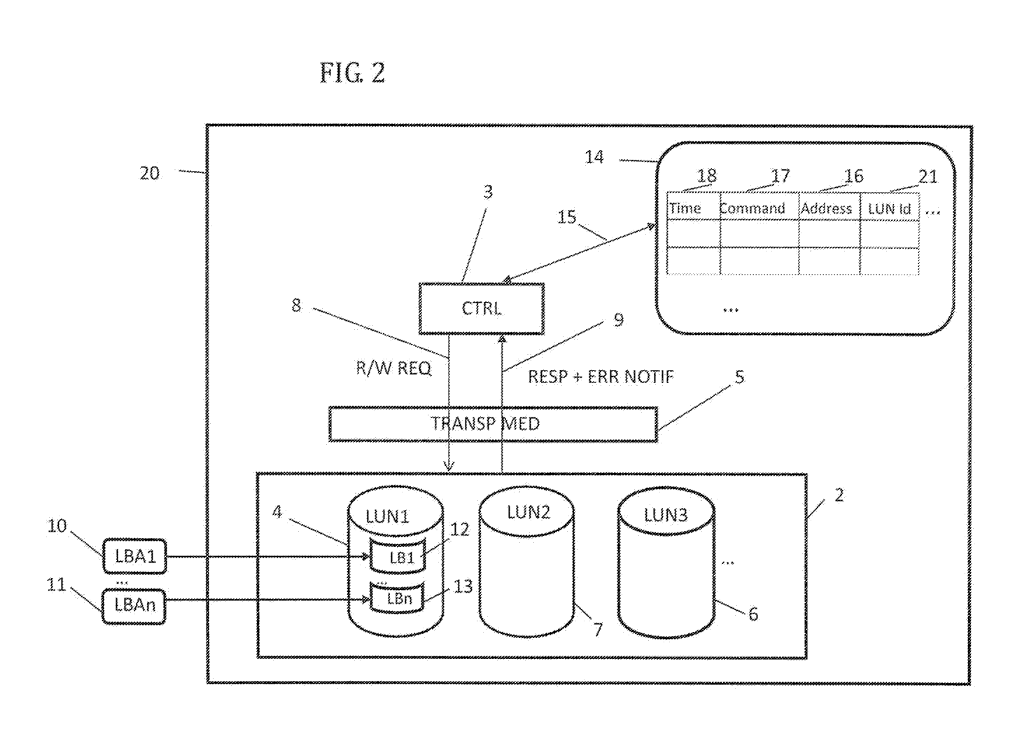

FIG. 2 is similar to the background architecture of FIG. 1 but shows a storage system 20 with dataset 14 in the form of a database for storing information related to the commands including for each command, the respective address LBAn the command is applied to, and an identifier of the corresponding LUN (LUN Id 21) and an identifier of the storage medium. The combination of LUN identifier and LBA define the storage medium address from the controller's perspective. The LBA on its own may not suffice to uniquely identify an address because a same LBA can be used for different LUNs. Therefore, both the LUN identifier and the LBA are stored as part of the dataset. In a normal case, the LUN is a direct mapping or a superset of the storage medium boundary from the controller's perspective (e.g a LUN is a drive, or a LUN is a RAID array of one or more drives) a storage medium LUN management typically has a software associated with it (e.g resources, queues, logic, etc). Consequently, regardless of whether the LUN is a subset or a superset of the storage medium, some error behaviours can be associated with this LUN software. In all cases, a health test can be issued on a per LUN basis as well as performing the health test on the storage medium. Similar reference numerals to those used in FIG. 1 are used where appropriate.

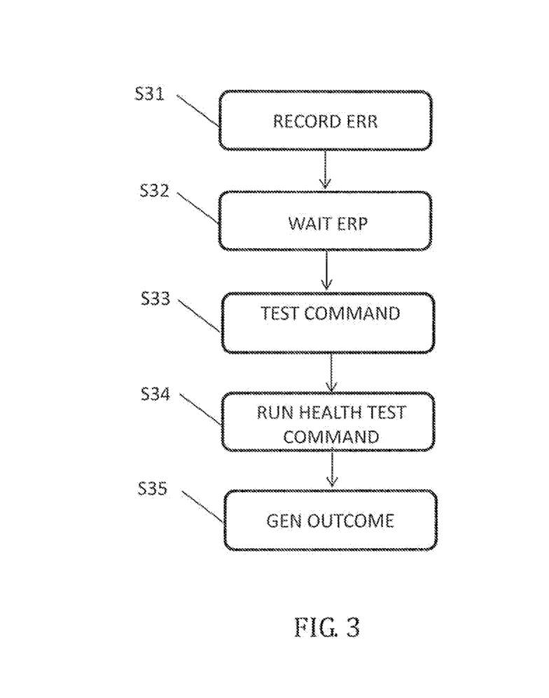

FIG. 3 illustrates a flow diagram describing method steps according to embodiments of the present invention. Throughout the description, where a LBA is recorded, it is assumed that an identifier of the LUN and an identifier of the storage medium uniquely locating the logical block are also recorded. For simplicity, only the LBA appears and the LUN identifier and storage medium identifier have been omitted.

In step S31, information about a command whose execution returned an error is recorded into a dataset 14. When the command is targeted at a particular address of a Logical Unit, that address (LBA) is recorded as the address where the error occurred together with the command syntax. When a command which is not targeted at a particular LBA generates an error, a LBA that is indicative of the location where the error could have occurred is recorded in the dataset 14 for future use in a health test. Examples of such LBAs include: “last read LBA”, “last written LBA”, “last LBA used for any command”. If the Test Unit Ready which does not contain any LBA is originating an error condition, any one of the aforementioned LBAs could be recorded in the dataset 14. The information recorded as part of an indication of an error occurrence includes, but is not restricted to: the command 17, the outcome of the command (not shown in FIG. 2), the LBA indicating the location of an error 16, some time information 18, and other information not shown in FIG. 2 such as the type of error, the type of the command that stimulated the error indication, the type of medium whose location was being accessed, an identifier of the storage medium where the error occurred etc. Depending on the type of error, the aforementioned list of information may vary. For example if the error reported is a transport error, the address returned may correspond to an address of a transport means used for carrying the command. It could be the address of a bus or any other means of transporting 5 a command between the controller 3 and one storage medium 2.

Recording a command may involve, as indicated above, recording a syntax of the command or a string associated with the command. It also includes recording parameters passed to the command such as the LBA the command is being sent to.

The outcome of the command is typically the result indicating whether the command succeeded or failed. The method step S31 according to embodiments of the invention records an outcome indicating a failure. The error itself is recorded as the outcome includes the error.

The type of an error may indicate for example whether the error is a “drive medium error”, a “transport error”, or a “drive internal error”, or whether a command took “longer than expected” to complete. Other types of errors may be recorded in the dataset 14 when such errors occur.

The time information 18 can include for example the time at which the command that generated the error condition was sent. It could also include the time at which a response indicating the error was received. A dataset of information 14 may additionally include a reference timer for each type of command which indicates the maximum acceptable time before a response is expected following the requesting command. For example, if for a Read command a timer is set at one millisecond and a response is received thirty milliseconds after the Read request was sent at a LBA, an error will be recorded in the dataset with the time of the response and the delay of the response. Then the same Read command will be replayed at a later time to verify if it takes the same amount of time for receiving a response.

Other information not mentioned above may also be recorded in the dataset 14. We assume that information recorded is appended to the dataset, so that a history of recordings is available from the dataset. In many respects, the dataset 14 may resemble a trace of multiple entries, where each entry corresponds to a command that generated a specific condition (e.g an error) along with its respective outcome. Each entry corresponds of course to a LBA of a logical unit of a storage medium where an error occurred or might persist. In case a storage system comprises several storage mediums, the dataset may feature three dimensions where the third dimension is for recording an identifier of a storage medium where an error occurred. When the LUN is made from the entire medium (or mediums), then the LUN identifier would be the third dimension. For each storage medium, the two dimensions of the dataset described above are available for recording information including the addresses or LBAs of locations of errors. It is noted that the dataset is a structure that can take the form of a table or a dynamic linked list and where appropriate a three dimension table or a collection of linked lists.

In step S32, following the reception of an indication of an occurrence of an error, and the recording of the command that caused the error, an ERP is completed. Some ERPs such as drive ERP occur as a result of normal Input/Output operations. In some storage systems, as soon as an error is indicated on a drive, an ERP is launched to attempt to fix the problem. It was briefly indicated earlier how an ERP attempts, using stored coded information, to correct an error on a drive. An ERP may resolve the problem before the method is resumed in step S33.

In step S33, a test command sequence is composed to probe the health of a storage medium (e.g a drive). The sequence is chosen from the commands stored in the dataset 14 in step S31. The sequence may consist of one or more commands and the selection thereof may be made according to arbitrary criteria including the type of outcome produced by the at least one command. A logic may be implemented to select a command or a number of commands to be replayed in at least one sequence. The logic may for example cause the selection of the commands which have resulted in a drive error at a particular LBA in a time frame (e.g in the last two months). The choice of the sequence may be arbitrarily chosen by the logic and a set of commands may be replayed in a number of different sequences.

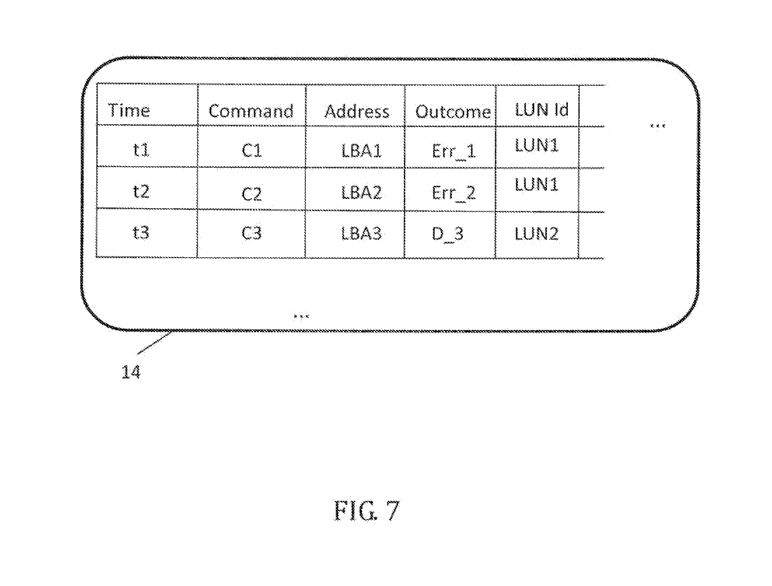

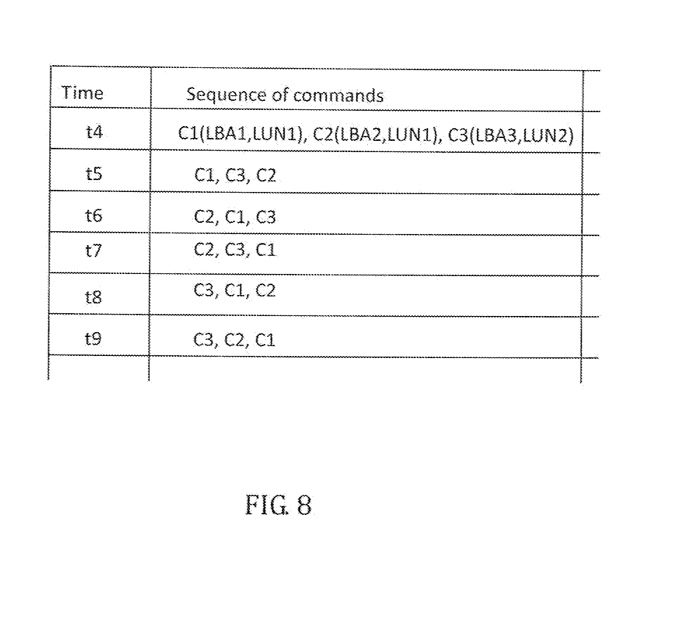

To illustrate step S33, we refer now to the table of FIG. 7 which exemplary represents recorded commands in the dataset 14 which have resulted in a fault or an abnormal behaviour. FIG. 7 only gives a sample view of the dataset 14 which can contain other fields and information not represented. FIG. 7 illustrates a recorded LUN Identifier or LUN Id field for each entry. The command “C1” for example which was executed at time “t1” to perform an I/O operation at LBA1 resulted in an error “Err_{—}1” on LUN1 4. The command “C2” also caused an error “Err_{—}2” whilst attempting to access LBA2 on LUN1 4. The command “C3” issued at time “t3” obtained an excessively delayed response “D_{—}3” when it targeted LBA3 on LUN2 7. The logic that applies in this step may compose six different sequences (e.g six different sequences shown in FIG. 8), each of which containing one of the recorded commands C1, C2, C3 to be replayed in the future. The table of FIG. 8 illustrates an example only of such selection of sequences. This table presents a permutation of the commands C1, C2, C3 because each sequence is an arrangement of these commands in a different order. According to the table of FIG. 8, the sequence “C1, C2, C3” has been composed to be replayed in this order starting at time “t4” for example and the sequence “C3, C2, C1” at time “t9”. Any of the instants t4 to t9 where the sequences are selected and recorded is later than any of the recording times t1, t2 or t3. Of course each of the commands C1, C2 or C3 is selected to be replayed at the respective addresses LBA1, LBA2 and LBA3 on LUN1 and LUN2.

In step S34, one command or a sequence of commands is run to test the health of the storage medium (e.g drive). Several sequences may of course be executed. The commands run in step S34 are replayed according to a selection performed in S33.

Finally in step S35, for each command replayed or re-applied, an outcome is generated. Moreover an outcome of a sequence of commands replayed can be generated. The outcome of each command indicates whether the command was successful or failed. The outcome of a sequence of commands can be defined to be a success if each command in the sequence succeeded. Alternatively the outcome of a sequence can be taken to be a failure if at least one command in the sequence resulted in a failure. Hence S35 provides for example the means of checking whether a previously erroneous storage medium is still faulty. Such check is achieved by comparing the outcome of a replayed command or sequence of commands with the recorded corresponding commands or sequence of commands in the dataset 14.

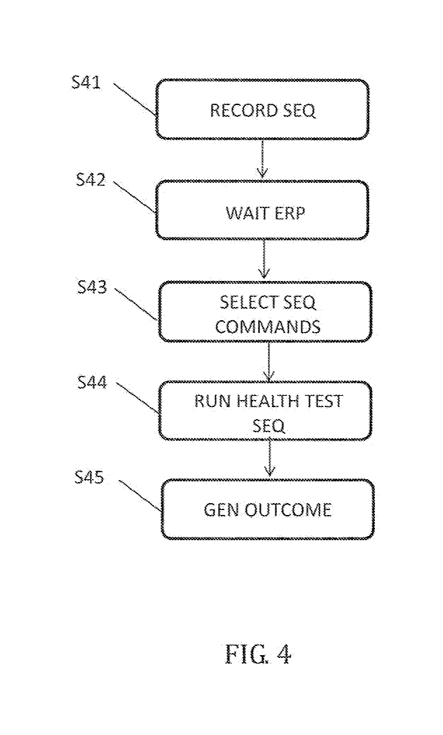

Another embodiment of the present method is described herein below with reference to the flow diagram of FIG. 4. In this embodiment, a sequence of commands is recorded when one of the commands of the sequence resulted in an error or an unexpected behaviour.

In step S41, each command played is recorded together with the status indicating the result of the command. When one command 8 results in an error or an abnormal behaviour, that command is recorded into a separate dataset 14 together with an address (e.g the LBA targeted by the command). Other information including the information listed in step S31 of the previous embodiments may also be recorded in the dataset 14. The last command that resulted in a failure in addition with the successful commands that preceded it, are recorded in the dataset. This sequence of commands may be replayed in a future health test. Sometimes, a failure in a system is caused by playing certain commands in a specific order or sequence. Therefore the method according to this embodiment attempts to reproduce a sequence of commands that led to a failure in order to diagnose whether the failure was actually due to that particular sequence. The specific structure of the dataset 14 is not described and is left to implementation choices.

In step S42, following the reception of an indication that a command resulted in an error or an unexpected behaviour and the recording thereof, an ERP may be completed to resolve the problem.

In step S43, the selection of commands that preceded a command that resulted in an error is performed. This selection is arbitrary and can be determined on the basis of a timer. For example, a logic can decide to select all the commands played in a period of five seconds immediately preceding the occurrence of the failure. Alternatively, the logic may select a predetermined number of commands immediately preceding the failed command. The order in which the selected commands would be run in a test such as a drive health test can be the chronological order in which the commands were executed. Alternatively the logic may select a sequence different from the sequence in which the commands were originally executed. Of course several sequences can be derived from the set of recorded commands for being replayed later.

In step S44, the sequence of commands selected is re-issued or replayed. It is possible to play several sequences where many sequences were selected in S43.

Finally in step S45, for each sequence of commands replayed or re-applied, an outcome is generated. As mentioned above, the outcome of a sequence of commands can be defined as a success if each command in the sequence succeeded and a failure if at least one command in the sequence resulted in a failure. Hence S45 provides the means of checking whether a sequence of commands which led to an error would still lead to an error if the commands are replayed in the original sequence or in a different sequence. Of course for testing, the outcome of a sequence of replayed commands is compared with the outcome of the sequence of commands recorded in the dataset. It also allows testing whether a sequence of commands that led to a failure will still lead to a failure after an ERP.

In another embodiment, every single command is recorded in the order in which it is executed regardless of whether the command results in a success or a failure. When a command results in a failure, it is singled out and recorded in a dataset. A number of commands that immediately preceded the failing command and a number of commands that were executed immediately after the failing command are recorded in the dataset as well. Hence a set of commands that were executed around the time of the execution of a failing command are recorded. This is different from previous embodiments where the selected sequence did not include commands that were executed after a failing command. Thereafter, from this set of commands, a sequence or several sequences can be derived each sequence including the command that caused the error. This record enables checking, when an error occurs at any particular position of a sequence of commands, whether the replayed sequence will suffer the same outcome. It can help to check in the future how and whether an error that occurred in the past at a location affects other locations. It can also help to determine whether a different sequence of a set of commands including a previously erroneous command would produce an error.

It is apparent from the foregoing that embodiments of the invention may provide a more efficient testing mechanism. They may also provide a more accurate testing mechanism of whether a storage medium has recovered from a previous problem.

Several examples of using the dataset to filter and select the commands to be replayed are now briefly described with reference to FIG. 3 or FIG. 4.

The dataset is constructed in step S31 or step S41 according to any of the previous embodiments. An ERP is further executed in step S32 or S42 for attempting to recover from errors recorded. In step S33 or S43, having the dataset of commands and inputs LBAs including the commands that generated errors, one or more commands whose execution generated an error, is selected on the basis of a filter. The filter can be chosen arbitrarily.

A filter can be defined to select the commands which were applied at a LBA on a storage medium of a particular type. A filter may cause the selection of commands which resulted in an error when applied at an address on a SSD drive.

A filter can be defined to select the input LBAs for which an ERP command had been executed on a particular storage medium type (e.g drive type). Filtering the LBAs associated with a completed ERP is a way to filter those LBAs that have contributed an error prior to the ERP. The selected addresses would form the input of a scheduled verification command. Thereafter, a command will be executed at the selected LBA(s) on the drive(s) of a selected type according to the steps S34 or S44.

In a further example, a filter can also be defined to select the LBAs associated with the completed ERP commands depending on the errors the ERP could fix. For example, if the set of information recorded in step S31 contains a number ‘N’ of LBAs indicating ‘N’ locations where an error occurred, the ERP command is executed at each of these LBAs in step S32. If following, the execution of the ERP command at these locations, N−1 problems have been solved; there remains one LBA for which the problem has not been fixed. In this case the remaining LBA address which indicates a persisting error (e.g medium error) is filtered as being the one LBA for which a test command needs to be reapplied in the future in steps S34 and S35.

In another example, the selection in step S33 or S43 of commands is performed on the basis of the age of the commands applied on a storage medium. The most recent entries of the dataset constructed in S31, S41 can be used as a filter to select the LBAs for which a test command needs to be executed in the future in steps S34/S44 and S35/S45.

In another example, where a complete storage medium timeline has been recorded in step S31 or S41, the selection of commands in step S33 or S43 to be replayed can be made on the basis of “error type”. In this case, it is possible to filter the LBAs on the basis of a particular type of error and for example on the basis of a storage medium where the error occurred. The selected LBA(s) is then used as input for the execution of test commands in steps S34/S44 and S35/S45.

In another example, the frequency of application of ERP can be used as well to select the LBAs for which commands should be issued for test verification in step S33/S43. For example, when an ERP is applied several times at a particular LBA, it infers that a problem persists in that location. Therefore, the LBA identifying such a location could be used as input for verifying whether the problem at this location persists in step S34/S44 and S35/S45.

In another example, the LBA ranges together with the times at which the commands were executed can be used to filter which LBAs should be selected in step S33 or S43.

In the above examples, it is illustrated how filtering can be applied to the constructed dataset to perform selective testing. This testing improves efficiency because when a filter is applied, the test commands target fewer LBAs than there would be in a standard testing procedure that for example scanned all LBAs. Moreover, the testing is more accurately targeted to the locations (i.e LBAs) and/or the commands which caused an error instead of targeting LBAs and/or commands that are unlikely to produce an error.

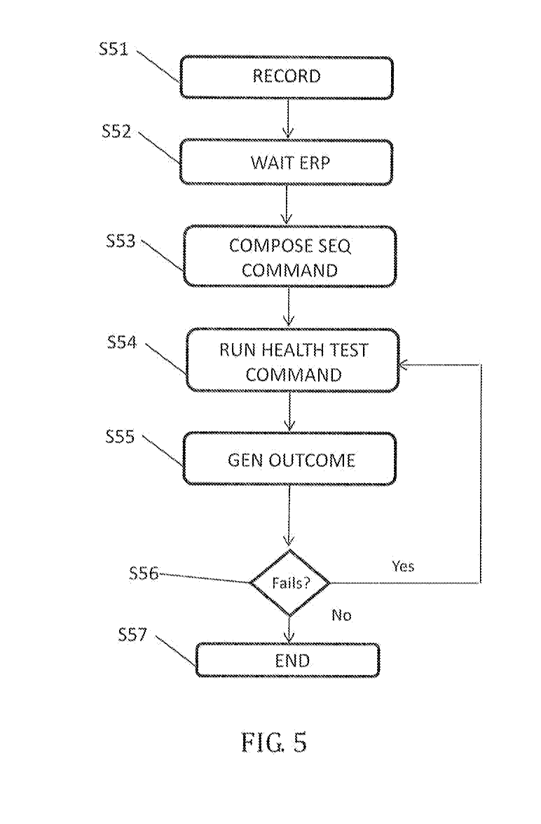

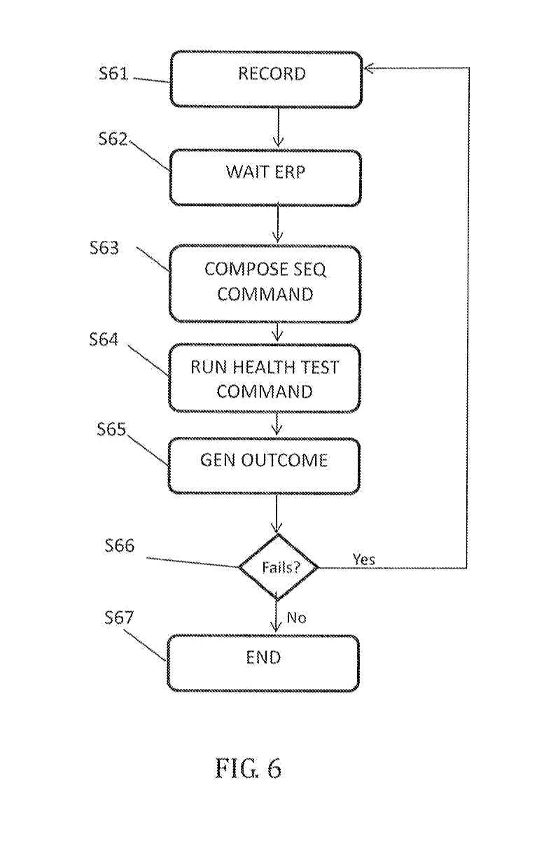

FIG. 5 and FIG. 6 show ways of replaying commands or sequence of commands and of managing the outcomes of the replayed commands.

In FIG. 5, the steps S51-S55 correspond to the method steps S31-S35 or S41-S45 presented in any of the embodiments above. In step S55, when the outcome of a command replayed or the outcome of a sequence of commands indicates a failure (S56), the process re-enters step S54. This re-entry can be executed after the expiry of a predefined delay to replay the command or the sequence of commands that resulted in a failure. This loop can be configured so that the command or the sequence of commands selected would be replayed for a predefined number of times or until it succeeds in step S57. In case, the command or the sequence of commands results in a failure in check step S56, the outcome of the commands is appended to the information dataset constructed in step S51.

In FIG. 6, the steps S61-S65 correspond to the method steps S31-S35 or S41-S45 of the previous embodiments. If a failure occurs in check step S66, the process reaches S61 so that the command or the sequence of commands which resulted in a failure is appended to the information dataset. Then the process starts again as in any previous embodiment with step S62 being an ERP step. This process can be regarded as an ERP feedback mechanism because the outcome of the ERP will impact future test commands selections and outcomes. If a failure does not occur in check step S66, the process reaches S67 and ends.

In embodiments of the present invention, each of the command Read and Write may be used for testing a storage medium (e.g drive). To apply safely the Write commands in a test sequence, each Write needs to be preceded by a Read. The Read enables preserving useful data. Thereafter the Write command can be applied without the risk of changing the data on the storage medium and thereby eliminating the risk of causing data corruption. This also gives the storage medium the option to re-write the data in a new location (drive internal region “reassign”) if this is needed to improve its health.

Throughout this description, it is assumed that the storage system comprises only one storage medium 2 and several LUNs. However, the foregoing embodiments are only illustrative and not restrictive as the method according to this invention equally applies to embodiments having one LUN and several storage mediums and/or several LUNs and several storage mediums.

Various embodiments of the present invention may be implemented by means of the controller 3 constructing the dataset 14 and selecting thereafter the commands to be replayed. The controller 3 may populate the dataset 14 through some communication links 15.

Many further modifications and variations will be apparent to one skilled in the art and the foregoing illustrative embodiments are given by way of example only and are not intended to limit the scope of the invention, which is being determined by the claims.

In the following claims, the word “comprising” does not exclude other elements or steps, and the indefinite article “a” or “an” does not exclude a plurality.

What is claimed is:

1. A method for testing a storage system to which is applied a command, the storage system having a storage medium and a controller, the command resulting in an outcome, the method comprising:
storing, in a dataset, information related to the command including: an address of the storage system the command is applied to, and an outcome of the command.

2. The method of claim 1, wherein when a sequence of commands is applied to the storage system, information related to the at least one command of the sequence is stored in the dataset including an outcome of the sequence of commands.

3. The method of claim 1, wherein the information related to the at least one command is stored in the dataset when the outcome of the at least one command is indicative of a fault.

4. The method of claim 2, wherein the outcome of a sequence of commands is indicative of a fault when the outcome of the at least one command of the sequence is indicative of a fault.

5. The method of claim 3, wherein the fault is one of: an error on the storage medium at the address or an error internal to the storage medium or a faulty behaviour on the storage system; an error that occurred during transportation of data between the controller and the storage medium.

6. The method of claim 1, wherein the information related to the command further comprises an identifier of the storage medium and/or an identifier of a storage unit which forms part of the storage medium.

7. The method of claim 3, wherein the fault is indicated by a delay between the command and a response thereof when said delay is longer than a predetermined delay.

8. The method of claim 1, further comprising: selecting one or more commands from the dataset each according to its respective outcome for re-applying said selected at least one command.

9. The method of claim 8, wherein a plurality of commands is selected from the dataset for re-applying each of the selected commands in one of: the sequence the commands were applied; a sequence different from the sequence in which the commands were applied.

10. The method of claim 8, wherein the selection of the at least one command is based on a time of applying the at least one command or a time of storing the information related to the at least one command.

11. The method of claim 8, wherein each of the at least one selected command is re-applied and the outcome of each re-applied command is compared to the stored outcome of the respective command.

12. The method of claim 8, wherein the outcome of the at least one command or sequence of commands re-applied is appended to the dataset.

13. The method claim 1, wherein the storage system comprises a plurality of storage mediums, each storage medium having a respective identifier, and when a command or a sequence of commands is applied to one of the plurality of storage mediums, the information related to the command or the sequence of commands is stored in the dataset with the identifier of said storage medium.

14. The method of claim 1, wherein the command is a request issued to the storage medium and the outcome of the command is in the response to the command.

15. The method of claim 1, wherein the command is a read command, or a write command, or a command for probing the storage medium.

16. A storage system comprising:
a first storage medium for storing data;
a controller for sending a command to the first storage medium and receiving and processing a response thereof, the controller being capable of interpreting an outcome of the command as a failure or a success; and
a second storage medium for storing a dataset of information related to the command or a sequence of such commands including for each command: an address of the storage system the command is applied to; and the outcome of the command or an outcome of the sequence of such commands.

17. The storage system of claim 16, wherein when the controller sends the command to the storage system, information related to the command is stored in the second storage medium including an outcome of the command.

18. The storage system of claim 16, wherein the information related to the command is stored in the second storage medium when the outcome of the command is indicative of a fault.

19. The storage system of claim 16, wherein the controller selects one or more commands from the second storage medium each according to its respective outcome for re-applying said command in one of: the sequence the commands were applied; a sequence different from the sequence in which the commands were applied.

20. The storage system of claim 16, wherein the storage system comprises a plurality of first storage mediums, each first storage medium having a respective identifier, and when the controller sends a command or a sequence of commands to one of the plurality of storage first mediums, the information related to the command or the sequence of commands is stored in the second storage medium with the identifier of said first storage medium.
